(19) United States
(12) Patent Application Publication
(10) Pub. No.: US 2003/0084046 A1
(43) Pub. Date: May 1, 2003

(54) Versatile database interface system

(75) Inventors: Jarrod Rogers, (US); Mamta Patel, (US)

Correspondence Address: SUGHRUE MION ZINN MACPEAK & SEAS, PLLC, 2100 Pennsylvania Avenue, N.W., Washington, DC, 20037-3213, US

(73) Assignee: ABM SYSTEMS LTD.

(21) Appl. No.: 09/983,676

(22) Filed: Oct. 25, 2001

(51) Int. Cl. G06F 7/00

(52) U.S. Cl. 707/10

(57) ABSTRACT

A database interface system and method are disclosed in which database interface screens and input parameters are configured or automatically generated using data stored in a structured database. The database system uses a modular structure comprising four layers: a generic user interface (UI) layer, a generic database interface (DI) layer, an application object (AO) layer and a database layer. Screen data (SD) is stored in the database. This system provides advantages of an architecture easy to adapt to different operating systems and different types of applications. User screens are easy to create, with a consistent look-and-feel and they can be displayed dynamically and be re-configured on the fly.

### CROSS-REFERENCE TO RELATED APPLICATIONS

This is the first application filed for the present invention.

### MICROFICHE APPENDIX

Not Applicable.

### TECHNICAL FIELD

The present invention relates to a database interface system and method. More particularly, the present invention relates to a database interface system in which database interface screens and input parameters are configured or automatically generated using data stored in a structured database.

### BACKGROUND OF THE INVENTION

Database interfaces are found in many types of computer applications and various systems exist for programming database interfaces which allow the specification of the data type and format of fields to be input or displayed in a database user screen, as well as to arrange the layout of the fields within a screen.

An example of state of the art database systems which provide an easy-to-configure user interface, is Microsoft Access™. It has a simple user interface that permits creation of forms and other data screens, by manipulating graphical objects on a screen. This allows a user to easily create and lay out a database form. Access™ also provides a “wizard like” series of dialog boxes to guide a user in creating forms and to permit selections from predefined templates. It provides menus for easily selecting from existing tables, fields or records for insertion into the form. Features such as range checking and masking of input data must be implemented independently for each field of each screen. This can lead to inconsistencies in behavior between fields or between screens and increases the debugging effort required to eliminate these inconsistencies. Also, because each form is created independently and layout information and text of the form are stored as part of the form, maintenance can be a cumbersome task. Modifying or updating database forms requires manual editing of each form. Global changes to forms must be performed individually, which compounds the problem. This problem grows as the number of forms increase. Also, forms are static and must be modified to adapt to different screen sizes.

Accordingly, an improved user interface for databases that is easy to configure, maintain and modify, remains highly desirable.

### SUMMARY OF THE INVENTION

The present invention provides a versatile database interface system that is easy to configure, maintain and modify. It uses a modular design wherein data tables, application logic and user interface are independent of each other.

The system uses a modular structure comprising four layers: a user interface (UI) layer, an application object (AO) layer, a database interface (DI) layer and a database layer. The database layer can be separated into two domains, application data (AD) and screen data (SD).

The UI layer provides generic interface functionality, to accept input from a user, and “paint” user-screens according to screen data stored in the database. The user interface code is also separated from the application object (AO) layer. This allows the same UI code to be used for different applications. As well, the UI layer can implement security features by providing different levels of permissions to different users or user categories. These levels can be communicated through the DI layer to the database layer to control access privileges. By implementing security in the UI layer, security can be consistent from screen to screen and from application to application.

The AO layer defines the functional feature set of the application. The AO layer couples application data with application logic, and so defines the behavior of the database application as a whole. The AO layer can implement validation rules, define relationships between data items, and create new data that is an aggregate of existing data. Data relationships can vary in complexity, thus requiring coded logic. For example, the value of data in a specific field can determine if another field is required or perhaps not needed. As another example, if the database application is implemented as a retail store system, the AO layer logic can be configured to provide features such as range checking for prices, discounts and ages, inventory control tools, personnel tools, tax calculation and logging tools, etc. If the database application is implemented as a professionals' office management system, the AO layer logic can be configured to provide client database tools, file tracking tools, diary and bring-forward tools, etc.

The UI layer can also provide navigation tools, to allow users to move from screen to screen. Navigation can be based on history of movements to allow retracing steps or recovering from user errors. Pull down menus, tree browsing, web style navigation and hyper-linking tools can also be implemented in the UI layer.

The DI layer provides an interface between the AO layer and the database layer. The DI layer controls database queries and commands to one or more database domains. For example, if the application data is stored in a separate domain from screen data, the DI layer will route the transactions to the appropriate domain. The DI layer can be adapted to communicate with different database engines without requiring re-design of the AO and UI layers.

The database layer contains the application data (AD) and the screen data (SD). Application data is the information that is normally considered data by a user. The AD database behaves as in a standard database.

Screen data can be stored in the same database as application data. In a preferred embodiment, screen data is stored in a separate domain of the database. Forms and other user screens are stored as screen data. Examples of screen data include form attributes such as layout, text labels, field types and field attributes. Field attributes can include field type, field size limits, data ranges and masks. In this way, data about a user screen is separated from the code required to implement the user interface.

Advantages of this modular structure include ease of configuring and updating user screens and database forms. Maintenance can be performed by persons who are knowledgeable in the information stored in the database. That is, business experts can now tailor their systems directly to suit their needs without requiring the services of a computer programmer.

Having user screen information stored in a database provides additional advantages. User screens can be displayed dynamically, with screen information being retrieved from the screen data database. Updating screen information can be as easy as updating a database record. This allows the user screens to be re-configured “on the fly”, either locally or remotely over a network. Also, it is easy to implement search and replace tools for global modifications to multiple user screens.

Another advantage of the modular structure is that it is easier to implement improved consistency of user screens and provide a consistent look-and-feel. This makes data entry and retrieval easier for end users and speeds learning. It is also easier to implement internationalization of database screens and the user interface.

According to an aspect of the present invention, there is provided a versatile database interface system adapted to enable user access to a database application. The system comprises: a database adapted to store application data of the database application, and screen-data associated with the data; a generic database interface (DI) adapted to selectively retrieve application data and screen data from the database; a generic user interface (UI) adapted to control a display device to display the application data in accordance with the screen data; and an application object (AO) layer adapted to interact with the DI and the UI to implement a predetermined feature-set of the database application.

The UI may include any one or more of: a navigation module adapted to enable a user to at least select data to be accessed from the database for display; a structure module adapted to display a structure of the database; an error module adapted to inform a user of errors detected by either one or both of the UI and AO layer; and an editing module adapted to enable a user to edit at least a portion of the screen data, so as to modify at least the appearance of the data screen.

The screen data may include: attribute data indicative of one or more attributes of an associated data field of the database; and display data indicative of a desired appearance of the associated data field on the display device. The attribute data may include any one or more of: a permissible value range of data entered in the associated data field; and a mask for controlling a format of data entered in the associated data field. The display data includes at least: a field identifier indicative of a data field to be displayed on the display device; a field order indicative of a position, relative to other data fields, at which the data field should be displayed; and a field type indicative of a desired representation of the field on the display device.

According to another aspect of the present invention, there is provided a method of enabling remote client access to a database service through any one of a plurality of access points (AP) supported by one or more service providers. Upon successful authentication of a client using an AP, respective screen data associated with the client is accessed. The display of database service information on a monitor of the AP is controlled using the accessed screen data. As a result, the client is presented with a consistent user interface display, independent of the service provider supporting the AP.

According to yet another aspect of the present invention, there is provided a method of updating a data screen of a database application. The data screen is displayed on a respective display device of a remote client of the database application. The remote client includes a generic user interface (UI) adapted to control the respective display device to display the data screen in accordance with screen data retrieved from the database. In accordance with the invention, a screen editor module (comprised of the UI layer and specific screen data) is used to create updated screen data reflecting the updated data screen. The updated screen data is inserted into the database.

According to a further aspect of the present invention, there is provided a method of remotely updating a data screen in each one of a plurality of instances of a database application. Each instance of the database application includes a respective generic user interface (UI) adapted to display the data screen in accordance with screen data retrieved from a respective database. The method includes using a screen editor module to create updated screen data reflecting the updated data screen. The updated screen data is forwarded to each instance of the database application. Finally, in each instance of the database application, the updated screen data is inserted into the respective database.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating principle elements of a versatile database interface system in accordance with an embodiment of the present invention;

FIG. 2 is a block diagram schematically illustrating an exemplary retail store database application in which the present invention may be deployed;

FIG. 3 is a schematic illustration of a user screen display useable for management of the database application of FIG. 2;

FIG. 4 is a schematic illustration of a user screen display useable for a point-of-sale terminal of the database application of FIG. 2;

FIG. 5 is a block diagram schematically illustrating an exemplary automated banking machine database application in which the present invention may be deployed; and

FIG. 6 is a schematic illustration of a user screen display useable in conjunction with the automated banking machine database application of FIG. 5.

It will be noted that throughout the appended drawings, like features are identified by like reference numerals.

### DETAILED DESCRIPTION OF THE PREFERRED EMBODIMENT

For the purposes of the present invention, a “database application” shall be understood to refer to any combination of hardware, software, and stored data that implements a functionally useful data-oriented system. The term “database application” is used herein to emphasize that such a system incorporates logic in addition to merely storing data. The logic typically implements a predetermined feature set which governs the behaviors, functional characteristics, and capabilities of the system. For example, a database application designed for use in a retail store environment will normally include financial data, inventory and pricing data, and personnel data stored in a database. Logic executing in each machine within the retail store governs user access to, and manipulation of, this stored data. Thus, logic implementing the feature set of a Point of Sale (POS) machine, such as a cash register, enables a sales clerk to register sales. This logic may also implement security and/or validation rules, as well as automatically update the inventory and financial data to reflect each sale. Conversely, logic implementing the feature set of a Back Office System (BOS), such as a store management system, may facilitate automated generation of such items as: reports of various types; product purchase orders; payroll, etc.

For the purposes of the present invention, a “database domain” shall be understood to refer to any coherent arrangement of data that may be accessed using a single query. The data within a domain may be arranged in any combination of tables, documents or files, which may be physically resident in one machine, or distributed across two or more machines and accessible through a network. The use of the term “database domain” is used herein to emphasize that, from the point of view of a user interface, the domain appears to have a single coherent interior structure and presents a consistent picture of what data is accessible within it.

A “database engine”, as is well understood in the art, refers to a software application designed to enable the creation of database domains (as defined above), and providing a coherent syntax for accessing data stored in such domains. Exemplary database engines well known in the art include Oracle™, MS-Access™, D-Base™, Paradox™ and Postgres.

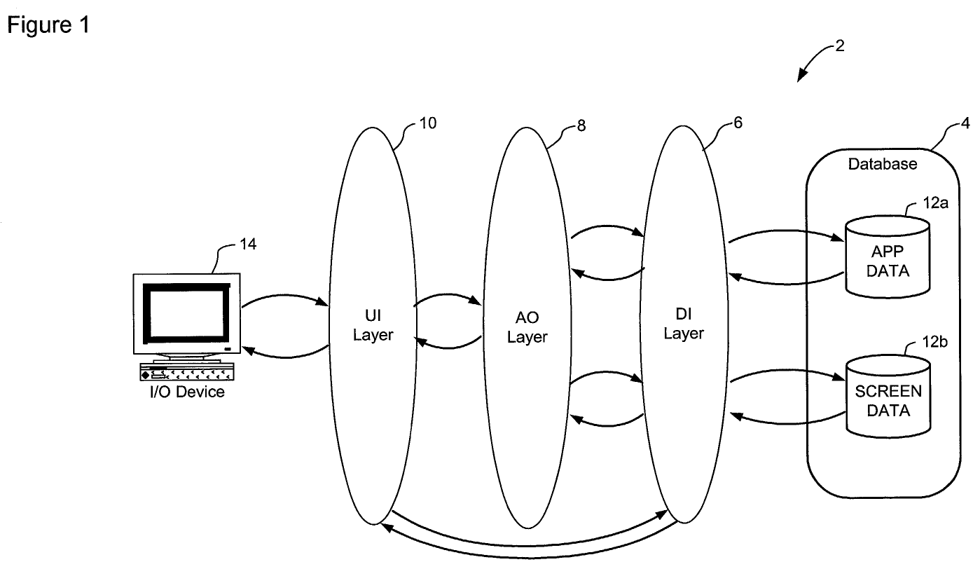

The present invention provides a versatile database interface system that is readily adaptable to implement a wide range of different database applications. FIG. 1 is a block diagram schematically illustrating principal elements of the present invention.

As shown in FIG. 1, the interface system 2 is designed using a modular architecture that includes a database 4; a database interface (DI) layer 6; an application object (AO) layer 8; and a user interface (UI) layer 10. The database 4 is designed in a conventional manner to store data within one or more database domains 12, each of which may be implemented using a suitable database engine. In the illustrated embodiment, the database 4 includes two database domains 12, namely, an application data domain 12a and a screen data domain 12b. The application data domain 12a is used to store application data which is entered, accessed, and/or otherwise manipulated by a user (not shown) during operation of the database application. For example, in a retail store environment, application data will normally include inventory and pricing information, financial information and possibly employee and payroll information. The screen data domain 12b is used to store various parameters controlling (among other things) the display of application data on a monitor of an input/output (I/O) device 14, as will be described in greater detail below. As may be appreciated, the application data and the screen data may be stored in separate domains 12a,b, as shown in FIG. 1, or may be stored together within a common database domain, as desired. In cases where two or more database domains 12 are used, each domain 12 may be based on a common database engine, or different database engines may be used for different domains, as desired.

The database interface (DI) layer 6 serves to mediate interaction between the AO 8 and UI 10 layers (and thus a user) and the database 4. For example, consider a database application in which a database domain 12 is defined using a database engine that supports the Structured Query Language (SQL). In this case, the DI layer 6 would respond to an information request (e.g., a search string entered by a user) to formulate an SQL query to extract the requested information from the database 4. Data returned to the DI layer 6 by the database 4, in response to the SQL query, can then be passed to the AO layer 8. The UI layer 10 then queries the AO layer 8 for display on a monitor. Thus, the DI layer 6 provides translation between the UI 10 and AO 8 layers and the database 4, thereby facilitating development and maintenance of the UI 10 and AO 8 layers independently of the database engine used to define the database 4.

The application objects (AO) layer 8 includes software that provides functionality specific to a particular database application. As such, the AO layer 8 will normally be designed with reference to at least the structure of the application data domain 12a within the database. However, because the DI layer 6 mediates interaction between the AO layer 8 and the database 4 itself, the AO layer 8 can be developed independently of the database engine and the protocols used to access and manipulate information within the database 4.

The user interface (UI) layer 10 implements software providing functionality that is generic to most, if not all, database applications. Thus, the user interface layer 10 can be considered as a generic user interface layer. At a minimum, this functionality includes interaction with an input/output (I/O) device 14 to display application data on a monitor 22 and receive user input; and interaction with the DI layer 6 to provide at least rudimentary functionality for accessing and manipulating data stored within the database 4. Various other types of generic functionality can be included in the UI layer 10, as desired. Exemplary functionality of this type may include any one or more of: navigation tools enabling a user to access selected functional features of the database application; search tools enabling a user to search the database 4 for records matching desired search criteria; a security module enabling user authentication services including limiting access to data stored in the database based on the user authorization; and an editing module enabling an end user to edit the screen data, and thereby control the display of information on the monitor.

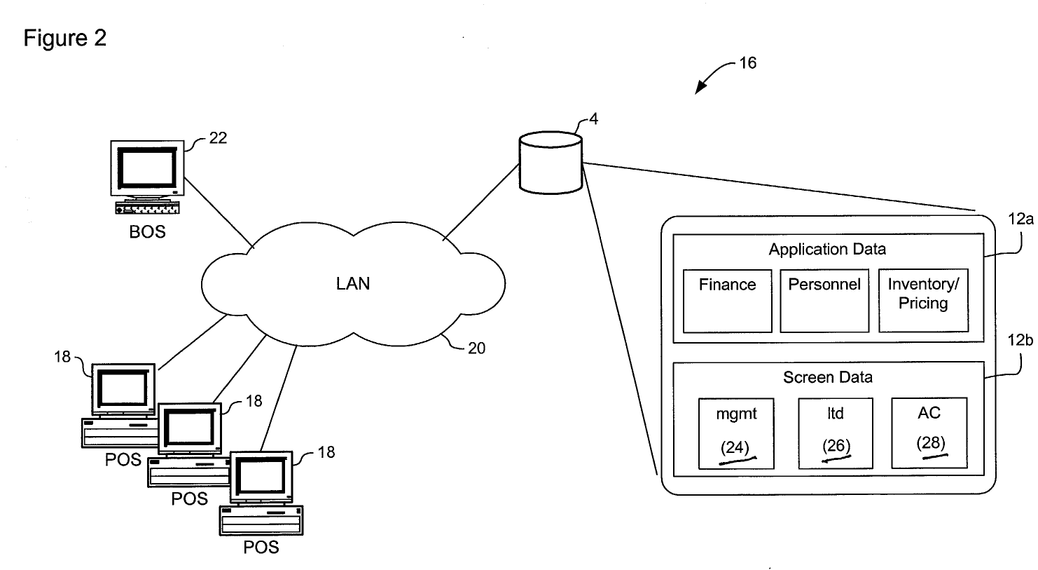

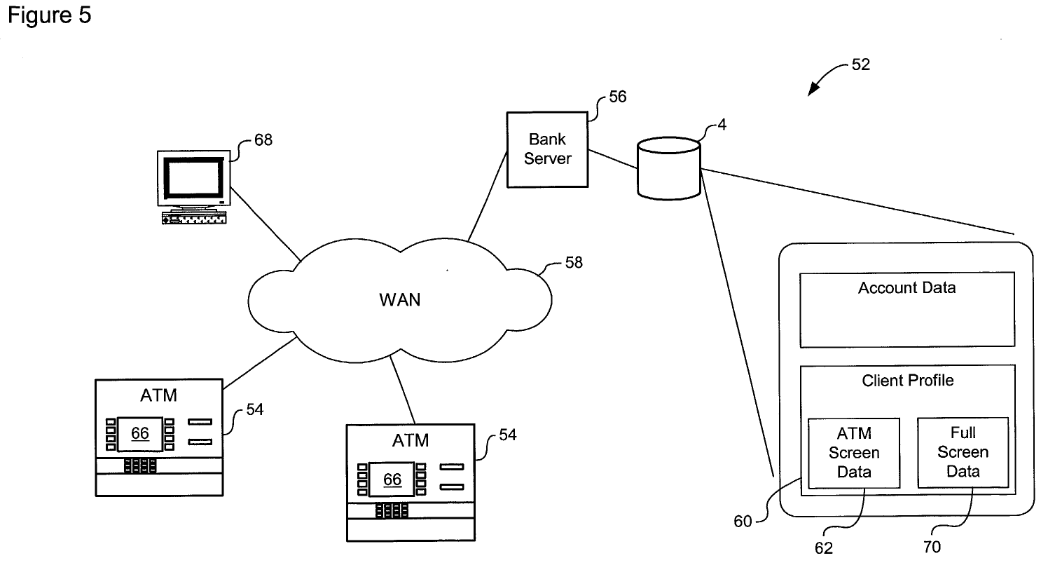

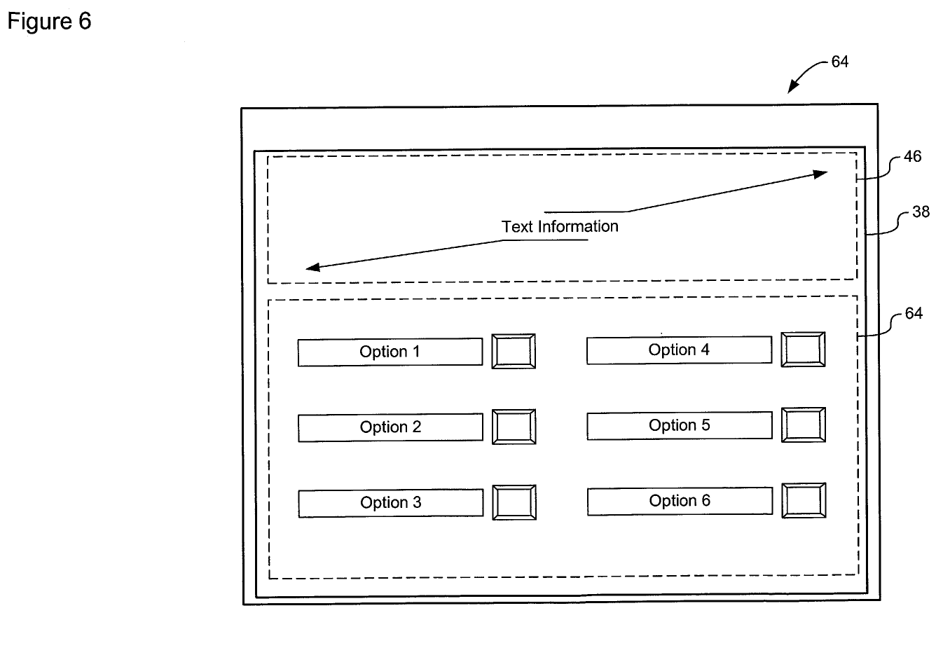

In general, by using the present invention, a database application is implemented by combining a database 4 (storing both application and screen data); the generic UI layer 10 and the generic DI layer 6 (which are generic to all database applications); and the AO layer 8 which provides desired functionality specific to the database application. The application data is stored within a database domain 12a which is structured in a manner well known in the art to facilitate storage and manipulation of the application data during operation of the database application. The screen data may be stored within the same database domain 12 as the application data, or in a separate domain 12, as desired. In either case, the screen data is used by the UI layer 10 to control the display of information on a monitor. As such, the structure of the screen data domain 12b (or that portion of a common domain in which the screen data is saved) can also be generic to many (or all) database applications. Thus, the deployment of a database application involves the design of the application data domain 12a within the database 4 and development of a suitable AO layer 8. These can then be used in conjunction with the generic UI and DI layers 10 and 6, and the generic screen data domain 12b to deploy a functioning database application. By suitable selection of the language used to develop at least the UI layer 10, the database application can also be rendered platform independent, so that the database application can be successfully deployed on computer systems operating under various different operating systems such as, for example, Microsoft Windows™, Unix™, Mac OS™ or Linux. In the following paragraphs, two exemplary database applications are described with reference to FIGS. 2 through 6. These exemplary database applications include a retail store management system described below with reference to FIGS. 2 through 4, and an automated banking system illustrated in FIGS. 5 and 6.

FIG. 2 is a block diagram schematically illustrating principal elements of a retail store management system 16 in which the present invention may be deployed. As shown in FIG. 2, the retail store system 16 includes a number of point of sale (POS) machines 18 serving as cash registers coupled to a central database 4 through a local area network 20. A back office system (BOS) 22 interacts with the POS machines 108 and the database 4, via the LAN 20, to enable management of the retail store. As shown in FIG. 2, the database 4 is divided into an application data domain 12a and a screen data domain 12b. The application data domain 12a contains inventory and pricing information, financial and accounting information, and personnel information, all of which are entered and manipulated by users of the system in the normal course of operation of the retail store. Conversely, the screen data domain 12b contains information used by the database application 16 to control the display of information on each of the POS 18 and BOS 22 machines. As is well known in the art, the database 4 may be located in the BOS 22, or in a central server machine (not shown) and accessible by the POS 18 machines and the BOS 22 through the LAN 20. Similarly, the UI 10, AO 8 and DI 6 layers of the database application 16 may be instantiated in each of the BOS 22 and POS 18 machines, in which case the DI layer 6 is enabled to interact with the database 4 via the LAN 20. Alternatively, the UI 10, AO 8 and DI 6 layers of the database application 16 may be co-resident with the database 4 on a central server (not shown), with each of the BOS 22 and POS 18 machines operating as dummy terminals slaved to the central server. In either case, the UI 10 and DI 6 layers of the database application 16 are generic, and therefore do not contain any logic or data that is specific to the implementation of the database application 16 in a retail store environment. Application specific logic is contained in the AO layer 8, which is designed in conjunction with the structure of the application data domain 12a to facilitate the desired functionality of the database application 16 for controlling and managing operations of the retail store. Like the UI 10 and DI 6 layers, the structure of the screen data domain 12b will normally be generic to all database applications, and thus would not normally be modified to reflect specifics of the retail store environment in which the database application is to be implemented. However, while the structure of the screen data domain 12b is generic, the information stored within that domain can readily be selected to provide the specific displays (and functionality) required by the retail store. Thus, for example, the screen data may include management information (Mgmt) 24 defining a “management” screen display providing extensive functionality for management of the retail store and, if desired, administration of the database application. The screen data domain 12b may also include “limited” screen data (ltd) 26 defining a screen display which provides a limited view of the application data, and corresponding limited access to the functionality of the database application 16. As will be appreciated, the management screen data 24 will normally be used by the BOS 22 machine in the normal course of management of the retail store, while the limited screen data 26 would normally be used in each of the POS machines 18 to implement the functionality of a cash register. In each case, selection of the appropriate screen data can readily be made by the UI layer 10 using, for example, a user (or device) identifier and information concerning access authorizations (AC) 28, which may conveniently be stored within the screen data domain 12b. Thus, upon start up of a machine (and/or log in of a user), the UI layer 10 can utilize the user and/or device identifiers to extract corresponding access authorization information 28 from the screen data domain 12b and, on the basis of this authorization data, extract the appropriate screen data from the screen data domain 12b to control the display of information on the involved machine.

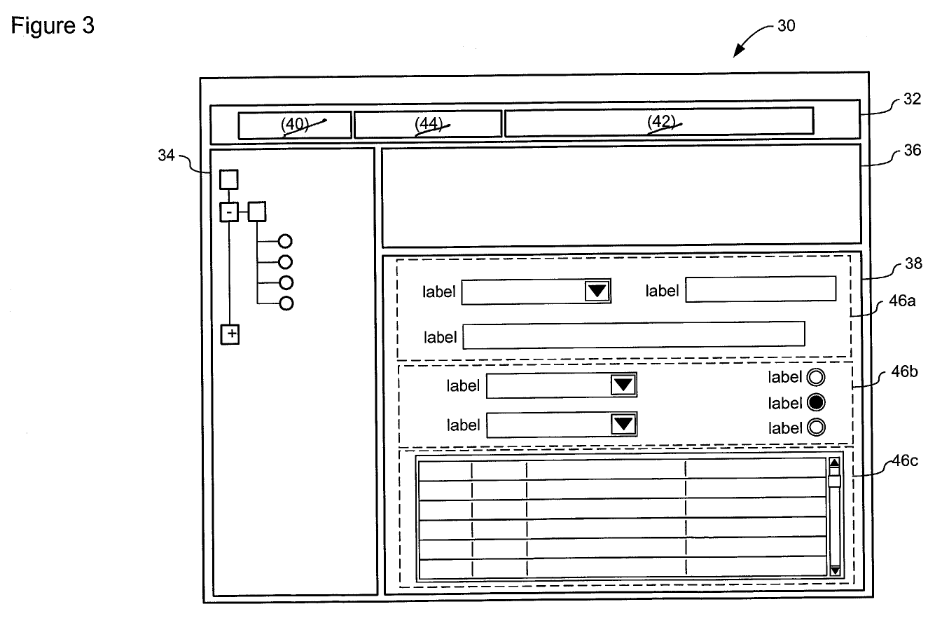

FIG. 3 is a schematic diagram illustrating principle elements of an exemplary database management screen 30, such as may be displayed by the UI layer 10, based on management screen data 24 extracted by the UI layer 10 from the screen data domain 126. As may be seen in FIG. 3, the management screen 30 is divided into a set of four panels 32, 34, 36, 38 which may be used to display various types of information and/or access functionality of the database application. As may be appreciated, these panels may be referred to as “generic” or “application specific”, depending on whether their contents (or functionality) are provided exclusively by the UI layer 10 (and thus generic to all database applications), or specific to the environment in which the database application is implemented (i.e., a retail store, following the example of FIG. 2 ). Exemplary generic panels illustrated in FIG. 3 include a control panel 32; a navigation panel 34; and an errors panel 36. Each of these panels may be displayed alone, or in any combination, and are controlled by logic embedded within the UI layer 10. The management screen 30 illustrated in FIG. 3 also includes an application data display panel 38 for accessing application data and functional features implemented by the AO layer 8. Thus, it will be appreciated that the application data display panel 38 will be application specific. Each of the above mentioned panels are described in greater detail below.

The control panel 32 provides generic functionality for controlling the management screen 30 and accessing application data from the database 4. Exemplary generic functionality that may be provided by the control panel 32 includes (but is not necessarily limited to): panel controls 40 for controlling whether or not either of the navigation 34 and errors panels 36 are displayed; searching tools 42 enabling a user to search the application data domain 12b to extract information matching search criteria defined by the user; and display history controls 44 enabling a user to easily recall previously displayed data in the application data panel 38 (as will be described in greater detail below). As may be appreciated, the logic required to implement the above-noted functionality of the control panel 32 can be readily designed in such a manner as to be fully independent of the structure of the application data domain 12a and the functionality implemented by the AO layer 8. In some cases, implementation of desired searching functionality will require awareness of at least the field identifiers in which application data is stored. However, this information may be stored within the screen data domain 12b during design of the application data domain 12a or, alternatively, the UI layer 10 may include suitable logic for probing the application data domain 12a to discover field identifiers (which may then be stored in the screen data domain 12b). In either case, the logic required to implement the searching tools 42 is generic to all database applications and, as such, can be conveniently embedded within the UI layer 10.

The navigation panel 34 is preferably implemented to provide a convenient means by which a user can select a data view within the application data panel 38. As is well known in the art, a user typically does not wish to view the “raw” data stored in the database 4. Rather, selected fields of data are preferably displayed together in an arrangement that is meaningful and relevant to the user. Typically, this takes the form of multiple views or forms, each of which may display selected data fields and/or icons for opening other forms or otherwise accessing functional features of the database application. The navigation panel 34 of the management screen 30 provides a convenient tool by which the user can select a specific form for viewing in the application data panel 38. Various methods well known in the art can be used to implement this functionality. For example, multiple forms may be organized into a tree structure (as shown schematically in FIG. 3) and accessed graphically in a manner well known in the art. With this arrangement, the logic required to implement the tree structure, and access appropriate screen data to display a selected form within the application data panel 38, is generic across all database applications. Awareness of the identities of each of the data display forms can be obtained by form identifiers generated (possibly automatically) during the creation of each form and saved in the screen data domain 12b. In operation, a user may utilize the functionality of the UI layer 10 to expand a section of the tree structure, and select a form that the user wishes to view. In response to the user's selection, the UI layer 10 queries the database 4 (via the DI layer 6) to obtain screen data corresponding to the selected form. Based on the extracted screen data, the UI layer 10 can construct and display the selected data form within the application data panel 38 of the management screen 30, as will be described in greater detail below.

The errors panel 36 may be used to display error messages, usage tips, and/or other information. Any of these items may be generated internally within the UI layer 10, based on parameters specified in the screen data, or by operation of the AO layer 8, and forwarded to the UI layer 10 which will display the information. Context sensitivity of the messages can be accomplished by awareness of the data form currently being displayed within the application data panel 38, as well as a currently active field (i.e., the field in which the insertion point is currently located) within that data form. It will be appreciated that such awareness can readily be obtained on the basis of screen data retrieved from the database 4 as described above, and logic embedded within the UI layer 10 that is generic to all database applications. Additional application specific messages may be generated by the AO layer 8 and/or the database 4 and forwarded to the UI layer 10 for display. In this case, the contents of a message (which may be partially or entirely application specific) can be forwarded to the UI layer 10 using a predetermined generic protocol. Within the UI layer 10, generic logic may be used to display the received message content within the errors panel 36. In cases where the errors panel 36 is inactive (that is, not being displayed), messages can be accumulated and, if desired, the user forced to deal with the associated problems before saving. Depending on the severity of the messages received from the AO layer 8, messages may be displayed within a conventional pop-up window.

As mentioned previously, the application data display panel 38 is used to display selected fields of application data arranged within a predefined form, which may be divided into one or more predefined sub-forms 46a-c. For each sub-form 46, the selected fields, the arrangement of those fields (at least in terms of their relative position or sequential order) and the field type (e.g., any one of: text box, radio button, password, check box, combo box, multiple selection box, table, color pallet, pick-list or hyper link) are determined on the basis of screen data retrieved from the database 4. The data fill used to populate each of the fields within a sub-form 46 can be obtained from application data retrieved from the database 4 using the search tools 42 of the control panel 32 (as described above) and/or by operation of the AO layer 8.

As may be appreciated, because the contents and appearance of each sub-form 46 is governed by screen data saved in the database 4, existing sub-forms may be readily modified by making corresponding revisions in the applicable screen data. Similarly, new sub-forms may be defined by creating suitable screen data, which can then be saved within the screen data domain 12b of the database 4. In order to assist a user in defining and/or modifying screen data associated with a sub-form 46 (either a new or an existing one), form editing tools may be provided by the UI layer 10, possibly using previously defined screen data for this purpose. Updated screen data can then be inserted in the database 4. As mentioned previously, awareness of the structure of the application data domain 12a can be obtained by the UI layer 10 on the basis of appropriate structure data saved in the screen data domain 12b during definition of the application data domain 12a. Similarly, feature data indicative of application specific functionality implemented by the AO layer 8 can be prepared and saved in the screen data domain 12b during definition of the AO layer 8. Using this information, generic logic embedded within the UI layer 10 can be used to develop various menus, pick-lists and wizard-like tools to facilitate the creation and modification of data display forms and sub-forms. Once the new (or modified) screen data has been saved in the screen data domain 12b of the database 4, the contents of the navigation panel 34 can be updated. The new (or modified) form can be selected by the user from the information displayed in the navigation panel 34 and displayed in the application data display panel 38 as desired. As may be appreciated, the above-described process of defining new and/or modified screen data can be accomplished by a user during normal operation of the database application. In particular, because the contents and appearance of data display sub-forms 46a-c within the application data display panel 38 are governed by screen data stored in the database 4, any desired changes in a sub-form can be accomplished by corresponding changes in the screen data and without requiring any recompilation of either the UI 10 or AO 8 layers, and without re-starting the application. Display form revisions can therefore be made “on the fly”, without interrupting normal operation of the database application. This provides a significant advantage over conventional database interface systems in which at least a portion of the interface must be recompiled in order to implement any desired changes.

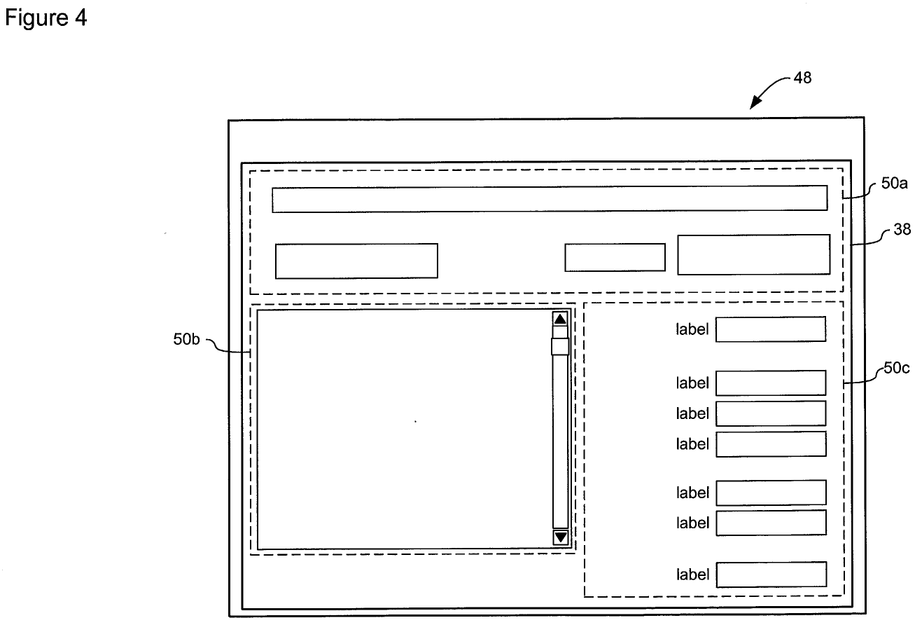

As described above, FIG. 3 is an exemplary illustration of a so-called “management” screen 30 in which all of the functionality of the database application, including generic and application specific functions of the UI 10 and AO 8 layers respectively, may be accessed. Conversely, FIG. 4 schematically illustrates a limited screen 48, which provides restricted access to the functionality of the database application. In effect, the limited screen 48 illustrated in FIG. 4 is entirely composed of an application data display panel 38 closely similar to that illustrated and described above with respect to FIG. 3. The control panel 32, navigation panel 34 and errors panel 36 of the management screen 30 are not included in the limited screen 48, so that it is not possible for a user of the limited screen 48 to navigate between different data display forms or access the functionality of the control panel 32. Similarly, the display of error messages is restricted to pop-up windows. As such, the limited screen 48 illustrated in FIG. 4 would be suitable for those situations in which the need to switch between different display panels is limited, and where the application data that needs to be displayed can readily be accommodated within a small number of display sub-forms. Within a retail store environment illustrated in FIG. 2, this situation will pertain to the point of sale machines (POS) 18. In this case, the back office system 22 may use the capabilities of the management screen 30 to define the contents and appearance of a “point of sale” display panel 48, which is then saved in the screen data domain 12b of the database 4 as described above. Upon start-up of a point of sale machine 18, the UI layer 10 may use a device identifier of the involved machine 18 and its associated access authorizations to query the database 4 and extract the screen data associated with the limited display screen 48. Similar access authorizations can also be associated with a user ID and/or password. This screen data 26 conveniently includes a reference to the previously defined point of sale display panel as the default view, which causes the UI layer 10 to retrieve the applicable screen data from the database 4 so as to display the point of sale display sub-form(s) 50a-c within the application data display panel 38 of the limited display screen 48.

In order to emphasize the versatility of the present invention, FIG. 5 illustrates implementation in an environment that differs markedly from that of the retail store environment illustrated in FIG. 2. In particular, FIG. 5 illustrates an on-line banking system 52 in which a number of automated teller machines (ATM) 54 are connected to a bank server 56 via a wide area network (WAN) 58 (such as the Internet). The automated teller machines 54 may be owned, operated and/or otherwise supported by various different service providers (such as banks), so that it will normally not be possible to obtain consistency in the screen display experienced by a customer across all of the automated teller machines 54. However, in accordance with the present invention, each automated teller machine 54 is provided with the generic UI 10 and DI 6 layers which enable each automated teller machine 54 to interact with the database 4 maintained by the bank server 56. As shown in FIG. 5, this database 4 contains, for each of its customers, a client profile 60, including ATM screen data 62 defining the contents and appearance of a desired ATM screen display. For the purposes of an automated teller machine, database navigation and screen editing tools are not required, so that the screen data may take the form of limited display screen 64 schematically illustrated in FIG. 6. As shown in FIG. 6, this limited display screen 64 is entirely composed of an application display panel 38, in which the client's account information may be displayed using one or more sub-forms 46. These sub-forms 46 may show text information and/or options that can be selected by the customer. The ATM screen data 62 can be used to define the content and appearance of each of the sub-forms. The language of text information can also be governed by the ATM screen data 62.

In use, when a customer uses an automated teller machine 54 to access on-line banking services, the customer negotiates a log-in and authentication procedure (e.g., using a banking card and password) in a conventional manner. Upon successful negotiation of the authentication procedure, the ATM machine 54 can query the bank server 56 to obtain appropriate screen data 62 from the client profile 60, and then uses this screen data 62 to govern the contents and appearance of the data display panel 38 displayed on the monitor 66 of the ATM machine 54. Using this system, the on-line banking customer can be provided with a consistent screen display independently of the type of ATM machine used to access their on-line banking services, or the service provider supporting that machine.

If desired, the bank server 56 may also permit the user to log in to on-line banking services using, for example, a conventional personal computer (PC) 68 connected to the WAN 58. In this case, upon successful negotiation of the log-on and user authentication procedures, the UI layer 10 resident in the user's PC 68 can query the client profile 60 to obtain full screen data 70 for controlling the contents and appearance of the screen displayed on the monitor of the PC 68. However, in this case, the screen data 70 returned to the PC 68 may be significantly more extensive than the ATM screen data 62 returned to an ATM machine 66. Thus, the screen displayed on the monitor of the PC 68 may be similar to that illustrated above in FIG. 3, to thereby enable the user to access the full range of available banking services including, if desired, the ability to customize the contents and appearance of the data display panel 38 and/or the contents and appearance of the screen displayed by an ATM machine 54. By this means, the user can control the appearance of the display screens displayed on an ATM machine 54, and this will be consistently reproduced on any ATM machine 54 through which the customer accesses his/her on-line banking services.

The embodiment(s) of the invention described above is(are) intended to be exemplary only. The scope of the invention is therefore intended to be limited solely by the scope of the appended claims.

We claim:

1. A versatile database interface system adapted to enable user access to a database application, the system comprising:
a database adapted to store application data of the database application, and screen-data associated with the data;
a generic database interface (DI) adapted to selectively retrieve application data and screen data from the database;
a generic user interface (UI) adapted to control a display device to display the application data in accordance with the screen data; and
an application object (AO) layer adapted to interact with the DI and the UI to implement a predetermined feature-set of the database application.

2. A system as claimed in claim 1, wherein the database, DI, UI and AO layer are co-resident.

3. A system as claimed in claim 1, wherein the database is remote from the DI, UI and AO layer, and accessible by the DI through a network.

4. A system as claimed in claim 1, wherein the database comprises at least one database domain within which the application data and screen data are stored.

5. A system as claimed in claim 4, wherein the application data and screen data are stored within a common database domain.

6. A system as claimed in claim 4, wherein the application data and screen data are stored within respective different database domains.

7. A system as claimed in claim 6, wherein all of the database domains within the database operate in accordance with a common database engine.

8. A system as claimed in claim 6, wherein each database domain within the database operates in accordance with a respective different database engine.

9. A system as claimed in claim 1, wherein the DI is responsive to either one or both of the AO layer and the UI to query the database.

10. A system as claimed in claim 1, wherein the UI is independent of any one or more of:
a platform on which the UI is implemented;
the feature-set of the database application; and
a database engine of the database.

11. A system as claimed in claim 1, wherein the UI comprises a data screen adapted to display application data retrieved from the database, at least an appearance of the data screen being controlled in accordance with the screen data.

12. A system as claimed in claim 11, wherein the UI further comprises any one or more of:
a navigation module adapted to enable a user to at least select data to be accessed from the database for display;
a structure module adapted to display a structure of the database;
an error module adapted to inform a user of errors detected by either one or both of the UI and AO layer; and
an editing module adapted to enable a user to edit at least a portion of the screen data, so as to modify at least the appearance of the data screen.

13. A system as claimed in claim 12, wherein the UI further comprises a security module adapted to limit user-access to each of the navigation, structure, error and editing modules in accordance with an authorization of the user.

14. A system as claimed in claim 1, wherein the application object (AO) layer is independent of any one or more of the database structure and the database engine.

15. A system as claimed in claim 1, wherein the screen data comprises:
attribute data indicative of one or more attributes of an associated data field of the database; and
display data indicative of a desired appearance of the associated data field on the display device.

16. A system as claimed in claim 15, wherein the attribute data comprises any one or more of:
a permissible value range of data entered in the associated data field; and
a mask for controlling a format of data entered in the associated data field.

17. A system as claimed in claim 15, wherein the display data comprises at least:
a field identifier indicative of a data field to be displayed on the display device;
a field order indicative of a position, relative to other data fields, at which the data field should be displayed; and
a field type indicative of a desired representation of the field on the display device.

18. A system as claimed in claim 17, wherein the field type comprises any one of: text box, radio button, password, check box, combo box, multiple selection box, table, color palette pick-list and hyper link.

19. A method of enabling remote client access to a database service through any one of a plurality of access points (AP) supported by one or more service providers, the method comprising, upon successful authentication of a client using an AP, steps of:
accessing respective screen data associated with the client; and
using the accessed screen data to control display of database service information on a monitor of the AP;
whereby the client is presented with a consistent user interface display, independent of the service provider supporting the AP.

20. A method as claimed in claim 19, wherein the database service is an automated banking service, and each AP is an automated teller machine (ATM).

21. A method as claimed in claim 19, further comprising a step of enabling the client to edit the respective associated screen data to customize the user interface display presented to the client by the AP.

22. A method of updating a data screen of a database application, the data screen being displayed on a respective display device of a remote client of the database application, the remote client including a generic user interface (UI) adapted to control the respective display device to display the data screen in accordance with screen data retrieved from the database, the method comprising steps of:
using a screen editor module (comprised of the UI layer and specific screen data) to create updated screen data reflecting the updated data screen; and
inserting the updated screen data in the database.

23. A method of remotely updating a data screen in each one of a plurality of instances of a database application, each instance of the database application including a respective generic user interface (UI) adapted to display the data screen in accordance with screen data retrieved from a respective database, the method comprising steps of:
using a screen editor module to create updated screen data reflecting the updated data screen;
forwarding the updated screen data to each instance of the database application; and
in each instance of the database application, inserting the updated screen data in the respective database.
